(19) United States
(12) Patent Application Publication
(10) Pub. No.: US 2006/0133354 A1
(43) Pub. Date: Jun. 22, 2006

(54) Apparatus and method for automatically updating address book in an SIP-based VoIP terminal

(76) Inventor: Jin-Suk Lee, Seoul (KR)

Correspondence Address: Robert E. Bushnell, Suite 300, 1522 K Street, N.W., Washington, DC, 20005-1202, US

(21) Appl. No.: 11/268,479

(22) Filed: Nov. 8, 2005

(30) Foreign Application Priority Data
Dec. 20, 2004 (KR) 2004-109028

(51) Int. Cl. H04L 12/66

(52) U.S. Cl. 370/352

(57) ABSTRACT

In an apparatus and a method for automatically updating an IP address of VoIP terminals, s VoIP terminal determines whether or not its IP address is changed by a Network Address Translation (NAT) server. If its IP address is changed, it transmits an IP update message to all other VoIP terminals registered in its address book. This allows automatic detection of a dynamic IP address of VoIP terminals, and thus provides convenience to a user in that the user can directly access other VoIP terminals without having to search for an IP address thereof.

### CLAIM OF PRIORITY

This application makes reference to and claims all benefits accruing under 35 U.S.C. §119 from an application for APPARATUS AND METHOD FOR AUTOMATICALLY UPDATING ADDRESS BOOK IN A SIP-BASED VoIP TERMINAL earlier filed in the Korean Intellectual Property Office on 20 Dec. 2004 and there duly assigned Serial No. 2004-109028.

### BACKGROUND OF THE INVENTION

1. Technical Field

The present invention relates to an apparatus and a method for updating an address book in a Session Initiation Protocol (SIP) based Voice over IP (VoIP) terminal. More particularly, according to the apparatus and the method of the invention, upon detecting any change in its dynamic IP address, a first SIP-based VoIP terminal transmits its changed dynamic IP address to all VoIP terminals registered in its address book so that the registered VoIP terminals can update the changed dynamic IP address of the first VoIP terminal.

2. Related Art

Information communication technology has been developed so as to allow a data network to transmit dynamic image and voice data, together with a previous simple data transmission, based upon VoIP. That is, VoIP is devised to enable voice and visual communication in a Packet Switched Network, which communication is relatively cheap and more efficient, in place of a Circuit Switched Network. Representative VoIPs may include SIP and H.323.

A VoIP system, using the Internet as a back-bone, typically includes SIP protocol servers and Personal Computers (PCs) connected to the Internet. The SIP protocol server is correspondingly connected to a Public Switched Telephone Network (PSTN) connected to a terminal, and the SIP protocol server is correspondingly connected to the PSTN, which is connected to another terminal.

A typical VoIP system cannot communicate with a specific counterpart without using a unique IP address in the Internet. However, this is not practical in a unique address system since permanent IP addresses are required for connection to the global Internet, and thus available IP addresses become insufficient due to consecutive address assignment.

In order to solve such a problem associated with private IP addresses, a private network uses Network Address Translation (NAT), which is a technology for allowing a network, using private IP addresses, to access the Internet using public IP addresses. The private IP addresses used in the network can be translated into public IP addresses when terminals using the private addresses access the Internet. In this way, more dynamic IP addresses can be used without conflicting with other IP addresses out of the private network.

VoIP communication, based upon such dynamic IP addresses, enables access via an SIP protocol server only with an ID (Identification) of a counterpart, regardless of the IP address thereof. The SIP protocol server generally includes subscriber terminals, a proxy server, a registration server, and the like. The proxy server acts according to a concept similar to that of a router in an IP network. When a transmitting terminal attempts to communicate with a receiving terminal, the proxy server transmits a message to establish a connection between the transmitting and receiving terminals.

The registration server and the proxy server are referred to as an SIP network server. The area managed by the SIP network server is referred to as a domain in the SIP network. Without the SIP network server, a subscriber cannot access a counterpart unless the IP address of the counterpart is known. That is, the subscriber must know the IP address of a desired counterpart in order to directly access the counterpart without the SIP network server. However, if the counterpart terminal is not fixed to a specific position, but is adapted to change its position, thereby also changing its IP address, a calling terminal cannot access the counterpart or called terminal when its IP address is changed.

### SUMMARY OF THE INVENTION

The present invention has been developed to solve the foregoing problems, and it is therefore an object of the present invention to provide an apparatus and a method for updating an address book in an SIP-based VoIP terminal. Specifically, upon detecting any change in its dynamic IP address, the SIP-based VoIP terminal can announce its changed dynamic IP address to all counterpart terminals registered in its address book so that the registered counterpart terminals can automatically update their address books.

According to an aspect of the invention, there is provided an apparatus for automatically updating an address book in an SIP-based VoIP terminal, the apparatus comprising: an IP determining unit for determining whether its IP address is changed by an NAT server; a memory for storing address data of second VoIP terminals; and a controller responsive to an IP address change for transmitting an IP update message to all second VoIP terminals registered in the memory.

According to another aspect of the invention, there is provided an apparatus for automatically updating an address book in an SIP-based VoIP terminal, the apparatus comprising: a detector responsive to reception of an IP update message from a second VoIP terminal for detecting an IP address of the second VoIP terminal from a data field of the IP update message; a memory for storing address information of the second VoIP terminal; a comparator for comparing the IP address of the second VoIP terminal, detected from the IP update message, with an IP address of the second VoIP terminal registered in the memory; and a controller responsive to the addresses of the second VoIP terminal being different from each other for updating the IP address of the second VoIP terminal registered in the memory with the IP address of the second VoIP terminal detected from the IP update message.

According to a further aspect of the invention, there is provided a method for automatically updating an IP address of VoIP terminals, the method comprising the steps of: determining at a first VoIP terminal whether its IP address is changed by a Network Address Translation (NAT) server; and, when its IP address is changed, transmitting an IP update message to all second VoIP terminals registered in its address book.

According to yet another aspect of the invention, there is provided a method for automatically updating an IP address of VoIP terminals, the method comprising the steps of: responding at a first VoIP terminal to reception of an IP update message from a second VoIP terminal by detecting an IP address of the second VoIP terminal from the IP update message; determining whether the second VoIP terminal was previously registered in an address book of the first VoIP terminal based upon the IP address of the second VoIP terminal; and when the second VoIP terminal is determined to have been previously registered, automatically updating a registered IP address of the second terminal with the IP address of the second VoIP terminal detected from the IP update message.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a block diagram illustrating the structure of an SIP-based VoIP system;

FIG. 2 is a block diagram illustrating the structure of an apparatus for automatically updating an address book in an SIP-based VoIP terminal according to a first embodiment of the invention;

FIG. 3 is a flowchart illustrating a method for automatically updating an address book in an SIP-based transmitting VoIP terminal according to the first embodiment of the invention; and

FIG. 4 is a flowchart illustrating a method for automatically updating an address book in an SIP-based receiving VoIP terminal according to the first embodiment of the invention.

### DETAILED DESCRIPTION OF THE INVENTION

The following description will present an apparatus and a method for automatically lo updating an address book in an SIP-based VoIP terminal according to a first embodiment of the invention in conjunction with the accompanying drawings.

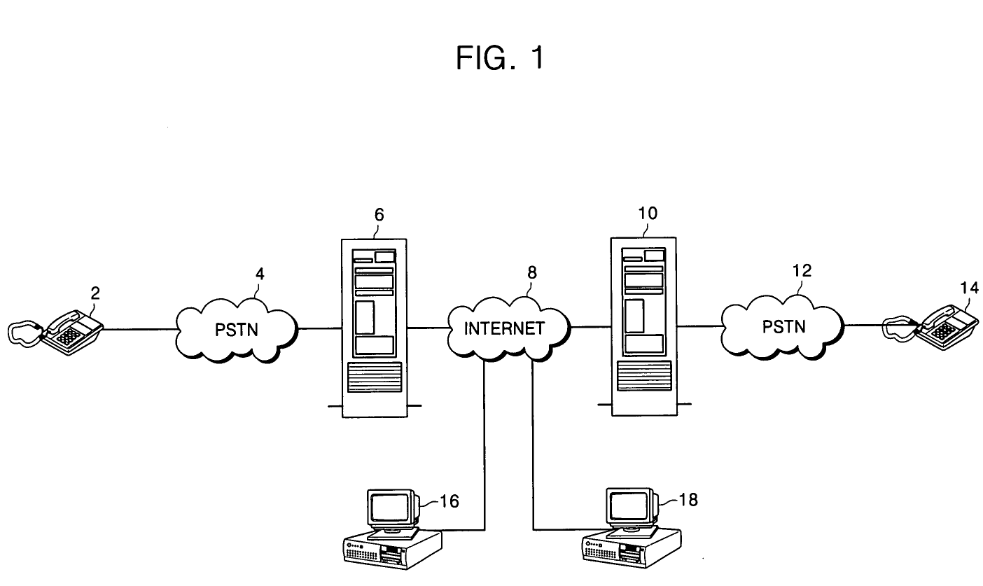

FIG. 1 is a block diagram illustrating the structure of an SIP-based VoIP system;

A VoIP system, using the Internet as a back-bone, is constructed as shown in FIG. 1. The VoIP system includes the Internet 8, used as the back-bone, and SIP protocol servers 6 and 10 and Personal Computers (PCs) 16 and 18 connected to the Internet 8.

The SIP protocol server 6 is correspondingly connected to a PSTN 4 which is connected with a terminal 2, and the SIP protocol server 10 is correspondingly connected to a PSTN 12 which is connected to a terminal 14.

Terminals, including the terminals 2 and 14 and the PCs 16 and 18, act as an endpoint capable of communicating voice (compulsory), image (optional) and data (optional) in a one-to-one communication or conference. Such a terminal can perform real-time bidirectional communication with the SIP protocol servers 6 and 10, other terminals, and the like.

The SIP protocol servers 6 and 10 are components that allow terminals (e.g., the terminals 2 and 14) connected to the Internet 8, (i.e., a packet-based network) to perform real-time bidirectional communication.

A typical VoIP system cannot communicate with a specific counterpart without using a unique IP address in the Internet. However, this is not practical in a unique address system since permanent IP addresses are required for connection to the global Internet, and thus available IP addresses become insufficient due to consecutive address assignment.

In order to solve such a problem associated with private IP addresses, a private network utilizes Network Address Translation (NAT). NAT is a technology which allows a network using private IP addresses to access the Internet using public IP addresses. In that regard, private IP addresses used in the network can be translated into public IP addresses when terminals using the private addresses access the outer Internet. In this way, more dynamic IP addresses than are permitted by regulation can be used without conflicting with other IP addresses outside the private network. VoIP communication based upon such dynamic IP addresses enables access via an SIP protocol server only with an Identification (ID) of a counterpart, regardless of the IP address thereof.

Although not shown in the drawings, the SIP protocol server generally includes subscriber terminals, a proxy server, a registration server, and the like. The proxy server acts according to a concept similar to that of a router in an IP network. When a transmitting terminal attempts to communicate with a receiving terminal, the proxy server transmits a message to establish a connection between the transmitting and receiving terminals.

In the latter case, the proxy server exists in a position physically the same as the registration server, and is adapted to deliver a call setup message from the transmitting terminal to the receiving terminal based upon the position in an SIP network of the receiving server which is registered in the registration server. With the registration server, subscriber terminals can register their current locations in the SIP network.

The registration server and the proxy server exist in a physically identical single unit, which is referred to an SIP network server. The area managed by the SIP network server is referred to as a domain in the SIP network. The domain indicates a range of an address rather than a specific address. Thus, the SIP network server manages a range of a specific address.

A domain to which a subscriber terminal basically belongs is referred to as a home domain, and the subscriber terminal can change the domain address to which it belongs. Without the SIP network server, a subscriber cannot access a counterpart unless the IP address of the counterpart is known. Thus, the subscriber must know the IP address of a desired counterpart in order to directly access the counterpart without the SIP network server.

However, if the counterpart terminal is not fixed to a specific position, but instead changes its position, thereby changing its IP address, a calling terminal cannot access the counterpart or called terminal when the IP address is changed.

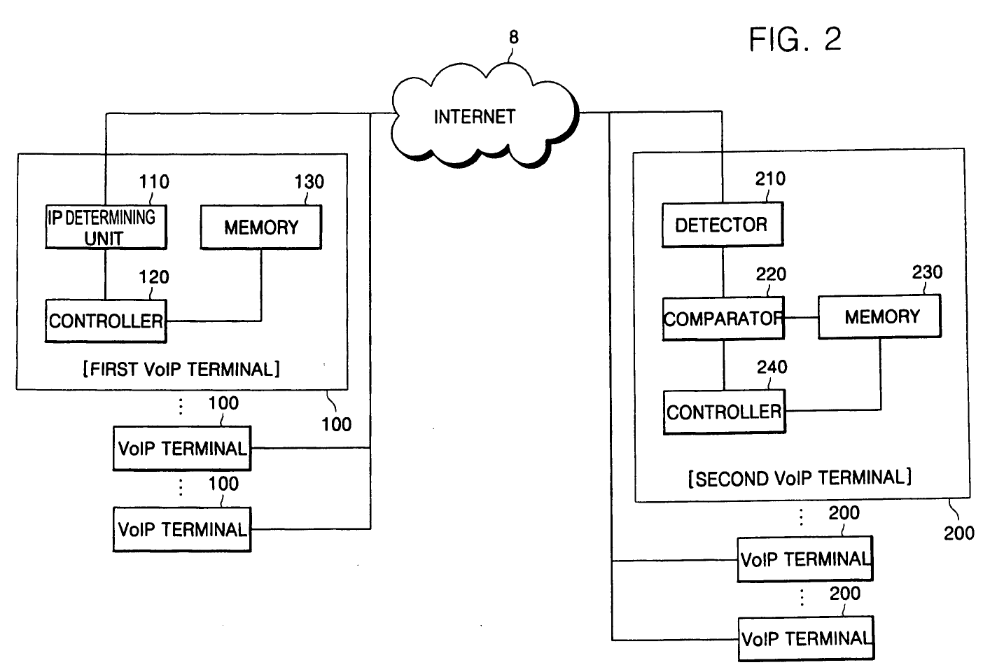

FIG. 2 is a block diagram illustrating an apparatus for automatically updating an address book in an SIP-based VoIP terminal according to a first embodiment of the invention. The invention is applied to transmitting VoIP terminals 100 and receiving VoIP terminals 200.

An apparatus for automatically updating an address book in a transmitting VoIP terminal 100 includes an IP determining unit 110, a controller 120, and a memory 130.

The IP determining unit 110 serves to determine whether the address of the transmitting VoIP terminal 100 is changed by a server (not shown) having an NAT function (hereinafter, the server will be referred to as “an NAT server”).

If the transmitting VoIP terminal 100 does not communicate for a predetermined period of time, the NAT server can assign the address of the transmitting VoIP terminal 100 to another VoIP terminal. After that, when the transmitting VoIP server 100 attempts access via the Internet 8, the NAT server assigns a new IP address to the transmitting VoIP terminal 100. Then, the transmitting VoIP terminal 100 detects that the new IP address is different from the previous one.

When detecting the change in the IP address of the transmitting VoIP terminal 100, the controller 120 transmits an IP update message to all receiving VoIP terminals 200 registered in an address book stored in the memory 130.

The IP update message transmitted to the receiving VoIP terminals 200 by the controller 120 has an identifier, such as “UPDATE”, in its header so as to identify itself as an IP update message, and has the changed IP address in its data field.

The IP update message is as follows:

UPDATE sip:callee@165.213.138.247:5060 SI/2.0 (This includes an identifier in the header to identify the IP update message, and an IP address of a receiving terminal.

From: <sip:Caller@165.213.138.101>

To: <sip:callee@165.213.138.247;user=phone>

In addition, the IP update message contains an IP address of a transmitting VoIP terminal before it was changed, and an IP address of a VoIP terminal supposed to receive an update message.)

CSeq:1 INVITE (indicates call connection).

The IP update message also contains Call-ID, Content-Type, Content-Length and a changed IP address 165.213.321.123 in its data field.

In this case, transmission/reception is performed via an actual originating IP address and a destination IP address in the header of the IP update message.

That is, the actual originating IP address uses 165.213.321.123 since the transmitting IP address is changed from 165.213.138.101 to 165.213.321.123.

In addition, the memory 130 serves to store address data of the VoIP terminal 200.

Further referring to FIG. 2, according to the first embodiment of the invention, an apparatus for automatically updating an address book in an SIP-based receiving VoIP terminal 200 includes a detector 210, a comparator 220, a memory 230 and a controller 240.

When the receiving VoIP terminal 200 receives an IP update message from a transmitting VoIP terminal 100, the detector 210 detects the IP address of the transmitting VoIP terminal 100 from a data field of the IP update message, and the comparator 220 compares the address of the transmitting VoIP terminal 100, obtained from the IP update message, with the address of the transmitting VoIP terminal 100 registered and stored in the memory 230.

In addition, the memory 230 stores address data of the transmitting VoIP terminal 100. If the registered IP address of the transmitting VoIP terminal 100 is different from that of the transmitting VoIP terminal 100 obtained from the IP update message, the controller 240 updates the IP address of the transmitting VoIP terminal 100, as stored in the memory 230, with that of the transmitting VoIP terminal 100 as received via the IP update message. After updating the IP address of the VoIP terminal 100 based upon the IP update message received from the transmitting VoIP terminal 100, the controller 240 transmits an update response/complete message to the transmitting VoIP terminal 100.

In this case, the controller 240 updates the IP address of the transmitting VoIP terminal 100, as stored in the memory 230, before transmitting an update response message to the transmitting VoIP terminal 100.

The IP update response message is as follows:

SIP/2.0 200 OK (This includes an identifier in the header to identify the IP update response message.

From: <sip:Caller@165.213.138.101>

To: <sip:callee@165.213.138.247;user=phone>

In addition, the IP update response message contains an IP address of the transmitting VoIP terminal according to the format of the IP update message, and an IP address of the receiving VoIP terminal which transmits the update response message.)

The IP update message also contains CSeq:1 UPDATE (identifying a response to the update message), Call-ID, Via, MAX-Forward, and Content-Length.

It is not compulsory to indicate the update response message in a data field.

In this case, transmission/reception is performed via the actual originating IP address and destination IP address contained in the header of the IP update response/complete message.

That is, the receiving IP address is 165.213.138.247, and an actual originating IP address of 165.213.321.123 is used since the transmitting IP address is changed from 165.213.138.101 to 165.213.321.123.

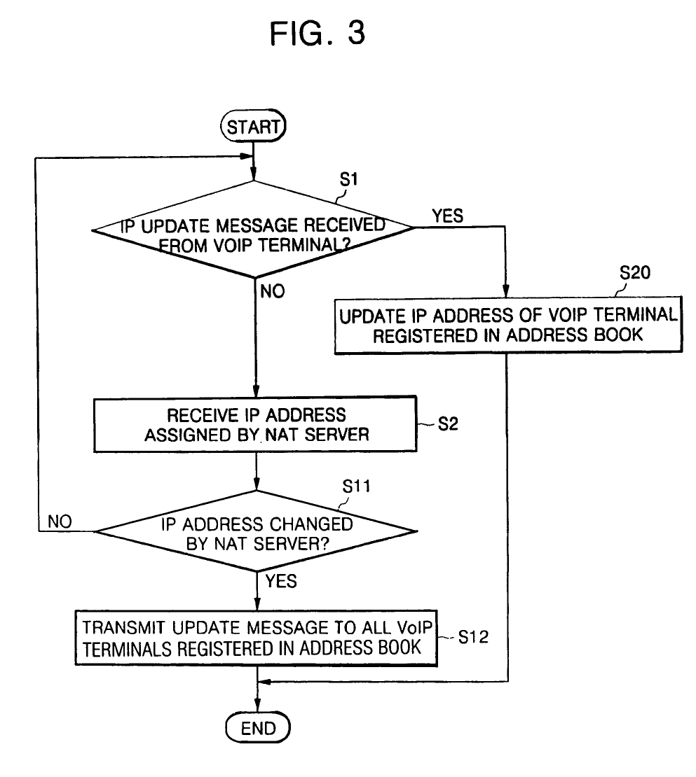

FIG. 3 is a flowchart illustrating a method for automatically updating an address book in an SIP-based transmitting VoIP terminal according to the first embodiment of the invention. Thus, a method for automatically updating an address book in an SIP-based VoIP terminal according to the first embodiment of the invention will be described with reference to FIG. 3.

When a transmitting VoIP terminal 100, which has performed packet transmission/receipt based upon an IP address 165.213.138.101 assigned from an NAT server (not shown), does not perform communication for a predetermined period of time, the NAT server assigns the IP address 165.213.138.101 to another VoIP terminal. Therefore, the transmitting VoIP terminal 100 must be assigned a new IP address by the NAT server in order to perform the transmission/reception of packet data on the Internet 8.

When the transmitting VoIP terminal 100 moves from the area of the current NAT server to that of another NAT server, it is assigned a new IP address by another NAT server.

First, in step S1, it is determined whether the VoIP terminal 100 has currently received an IP update message from another VoIP terminal 200.

If the IP update message is not received as determined in step S1, the VoIP terminal 100 is assigned an IP address by a NAT server IP in step S2.

Then, in step S11, the transmitting VoIP terminal 100 determines whether or not its IP address has been changed by the NAT server. When the transmitting VoIP terminal 100 is assigned a new IP address 165.213.321.123 by the NAT server, the transmitting VoIP terminal 100 is notified that its IP address is changed from 165.213.138.101 to 165.213.321.123.

If it is determined in step S11 that the IP address is changed from 165.213.138.101 to 165.213.321.123, the transmitting VoIP terminal 100 transmits, in step S12, an IP update message to all receiving VoIP terminals 200 registered in its address book. In this case, the transmitting VoIP terminal 100 transmits the IP update message to those VoIP terminals registered in the address book stored in a memory 130, as indicated in Table 1 below.

TABLE 1

| VoIP terminal | IP address |
|---|---|
| First VoIP terminal | 165.213.138.111 |
| Second VoIP terminal | 165.213.138.112 |
| . . . | . . . |
| Nth VoIP terminal | 165.213.138.n |

In this case, the IP address update message has an identifier “UPDATE” contained in its header. The IP address update message also includes the IP of a transmitting VoIP terminal, the IP address of a receiving VoIP terminal, and the changed IP address 165.213.321.123 of the transmitting VoIP terminal, all contained in a data field.

In this case, the IP update message is transmitted in the same format, with only the IP address 165.213.138.112, . . . , 165.213.138.n of the receiving VoIP terminal 200 being changed.

Then, the transmitting terminal 100 receives an update response message from the receiving VoIP terminal 200.

The update response message includes an identifier SIP/2.0 200 OK in its header, as well as an IP address 165.213.138.101 of the transmitting VoIP terminal and an IP address 165.213.138.247 of the receiving VoIP terminal which is transmitting the update response message. The update response message may further include letters so that an update in the data field can be recognized.

If the transmitting VoIP terminal 100 does not receive any update response message from the receiving VoIP terminal 200, it may retransmit the IP update message after waiting for a predetermined period of time, or it may discard the IP update message.

If the IP update message is received, as determined in step SI, the transmitting VoIP terminal 100 updates the IP address of the receiving VoIP terminal as registered in the address book stored in the memory 130.

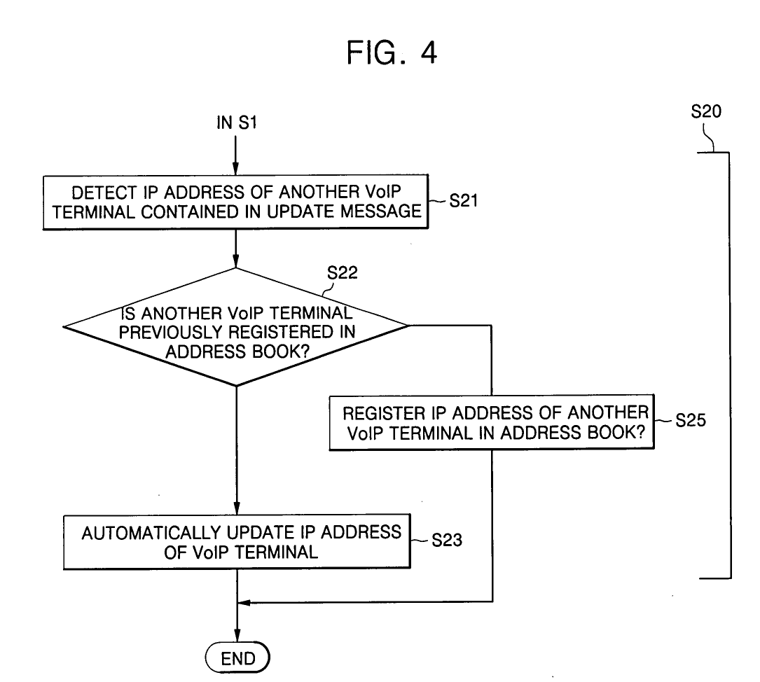

FIG. 4 is a flowchart illustrating a method for automatically updating an address book in an SIP-based receiving VoIP terminal according to the first embodiment of the invention. Thus, a method for automatically updating an address book in an SIP-based receiving VoIP terminal will be described with reference to FIG. 4.

First, when receiving an IP update message from a transmitting VoIP terminal 100, a receiving VoIP terminal 200 detects the IP address of the transmitting VoIP terminal from the IP update message in step S21.

The IP update message contains an identifier “UPDATE” which identifies it as an update message, an IP address 165.213.138.101 of the transmitting VoIP terminal, an IP address 165.213.138.247 of the receiving VoIP terminal to which the update message is being transmitted, and a changed IP address 165.213.321.123 of the transmitting VoIP terminal, all contained in a data field.

Therefore, the receiving VoIP terminal 200 detects the IP update message based upon the identifier “UPDATE”, and compares the addresses of the transmitting VoIP terminal based upon the IP address 165.213.321.123 in the data field.

In step S22, the receiving VoIP terminal determines whether or not the transmitting VoIP terminal 100 is previously registered in its own address book based upon the detected IP address 165.213.138.101 of the transmitting VoIP terminal 100. That is, the receiving VoIP terminal 200 searches for the VoIP terminal 100 in the address book of the memory 203, as indicated in Table 2.

TABLE 2

| VoIP terminal | IP address |
|---|---|
| First VoIP terminal | 165.213.138.101 |
| . . . | . . . |
| Nth VoIP terminal | 165.213.138.n |

In this case, based upon the IP address update message received from the transmitting VoIP terminal 100, the receiving VoIP terminal 200 detects that the transmitting VoIP terminal 100 is a first VoIP terminal, with its initial IP address 165.213.138.101 being changed to 165.213.321.123 as contained in the IP update message.

If the transmitting VoIP terminal 100 is determined in step S22 to have been previously registered, the receiving VoIP terminal 200 automatically updates the IP address of the transmitting VoIP terminal 100 in step S23. That is, the receiving VoIP terminal 200 updates the IP address of the VoIP terminal (i.e., the first VoIP terminal) 100 registered in memory 230 from 165.213.138.101 to 165.213.321.123.

When the IP address is automatically updated, the receiving VoIP terminal 200 transmits an update response message to the transmitting VoIP terminal 100, which transmitted the IP update message.

The update response message contains in its header an identifier SIP/2.0 200 OK to identify it as an update response message. The update response message also contains the IP address 165.213.138.101 of the transmitting VoIP terminal 100, the IP address 165.213.138.247 of the receiving VoIP terminal 200 of the update response message, and letters in a data field by which updating can be recognized.

In the meantime, if the transmitting VoIP terminal 100 is determined in step S22 to have not been previously registered, the receiving VoIP terminal 200 registers the transmitting VoIP terminal 100 in its address book in step S25. Alternatively, the receiving VoIP terminal 200 may discard the IP of another VoIP terminal according to the users.

According to the invention as described above, the apparatus and method for automatically updating an address book in an SIP-based VoIP terminal allow automatic detection of a dynamic IP address of VoIP terminals. This provides convenience to a user, such that the user can directly access other VoIP terminals without having to search for an IP address thereof.

Furthermore, since the user can directly access other VoIP terminals without communicating via an SIP network server, the cost of the SIP network server can be reduced with significant cost savings.

While the present invention has been shown and described in connection with the preferred embodiments, it will be apparent to those skilled in the art that modifications and variations can be made without departing from the spirit and scope of the invention as defined by the appended claims.

What is claimed is:

1. A method for automatically updating Internet Protocol (IP) addresses of Voice over IP (VoIP) terminals, the method comprising the steps of:
determining, at a first VoIP terminal, whether an IP address of the first VoIP terminal is changed by a Network Address Translation (NAT) server; and
when the IP address of the first VoIP terminal is changed, transmitting an IP update message to other VoIP terminals registered in an address book of the first VoIP terminal.

2. The method according to claim 1, further comprising the step of receiving an update response message from at least one of said other VoIP terminals.

3. The method according to claim 1, wherein the transmitted IP update message contains an UPDATE identifier, an IP address of the first VoIP terminal, a changed IP address of the first VoIP terminal, and IP addresses of said other VoIP terminals.

4. A method for automatically updating an Internet Protocol (IP) addresses of Voice over IP (VoIP) terminals, the method comprising the steps of:
upon receiving, at a first VoIP terminal, an IP update message from a second VoIP terminal, detecting an IP address of the second VoIP terminal from the IP update message;
determining whether the second VoIP terminal has been previously registered in an address book of the first VoIP terminal based upon the detected IP address of the second VoIP terminal; and
when the second VoIP terminal has been previously registered in the address book of the first VoIP terminal, automatically updating a registered IP address of the second VoIP terminal with the IP address of the second VoIP terminal detected from the IP update message.

5. The method according to claim 4, further comprising the step of responding to update of the registered IP address of the second VoIP terminal by transmitting an update response message to the second VoIP terminal.

6. The method according to claim 4, further comprising the step of responding to a determination that the second VoIP terminal has not been previously registered by registering the second VoIP terminal in the address book of the first VoIP terminal.

7. The method according to claim 4, wherein the IP update message received from the second VoIP terminal contains an UPDATE identifier, an IP address of the second VoIP terminal, a changed IP address of the second VoIP terminal, and an IP address of the first VoIP terminal.

8. A method for automatically updating Internet Protocol (IP) addresses of Voice over IP (VoIP) terminals, comprising the steps of:
(a) at a first VoIP terminal, when an IP address of the first VoIP terminal is changed by a Network Address Translation (NAT) server, transmitting an IP update message to a second VoIP terminal registered in a memory of the first VoIP terminal;
(b) at the second VoIP terminal, receiving the IP update message from the first VoIP terminal and updating an IP address of the first VoIP terminal registered in a memory of the second VoIP terminal;
(c) at the second VoIP terminal, transmitting an update response message to the first VoIP terminal; and
(d) at the first VoIP terminal, receiving the update response message from the second VoIP terminal, and completing IP address updating.

9. The method according to claim 8, wherein the IP update message contains an UPDATE identifier, a previous IP address of the first VoIP terminal, a changed IP address of the first VoIP terminal, and an IP address of the second VoIP terminal.

10. A Session Initiation Protocol (SIP) based Voice over Internet Protocol (VoIP) system, comprising a first VoIP terminal and at least one second VoIP terminal;
wherein the first VoIP terminal determines whether an IP address of the first VoIP terminal is changed by a Network Address Translation (NAT) server, said first VoIP terminal being responsive to a change of the IP address of the first VoIP terminal for transmitting an IP update message to said at least one second VoIP terminal registered in the address book; and
wherein said at least one second VoIP terminal is responsive to reception of the update message from the first VoIP terminal for updating an IP address of the first VoIP terminal registered in an address book of the second VoIP terminal, and for transmitting an update response message to the first VoIP terminal.

11. The SIP-based VoIP system according to claim 10, wherein the IP update message contains an UPDATE identifier, a previous IP address of the first VoIP terminal, a changed IP address of the first VoIP terminal, and an IP address of the second VoIP terminal.

12. An apparatus for automatically updating an address book in a Session Initiation Protocol (SIP) based Voice over Internet Protocol (VoIP) terminal comprising:
an IP address determining unit for determining whether an IP address of the SIP based VoIP terminal is changed by a Network Address Translation (NAT) server;
a memory for storing address data of second VoIP terminals; and
a controller responsive to change of the IP address of the SIP based VoIP terminal for transmitting an IP update message to the second VoIP terminals.

13. The SIP-based VoIP system according to claim 12, wherein the IP update message contains an UPDATE identifier, a previous IP address of the first VoIP terminal, a changed IP address of the first VoIP terminal, and an IP address of each of the second VoIP terminals.

14. An apparatus for automatically updating an address book in a Session Initiation Protocol (SIP) based Voice over Internet Protocol (VoIP) terminal comprising:
a detector responsive to reception of an IP update message from a second VoIP terminal for detecting an IP address of the second VoIP terminal from a data field of the IP update message;
a memory for storing address information, including an IP address of the second VoIP terminal;
a comparator for comparing the detected IP address of the second VoIP terminal with the IP address of the second VoIP terminal stored in the memory; and
a controller responsive to the detected IP address of the second VoIP terminal being different from the stored IP address of the second VoIP terminal for updating the IP address of the second VoIP terminal stored in the memory with the detected IP address of the second VoIP terminal.

15. The SIP-based VoIP system according to claim 14, wherein the controller transmits an update response message to the second VoIP terminal upon updating the stored IP address of the second VoIP terminal with the detected IP address of the second VoIP terminal.

16. The SIP-based VoIP system according to claim 14, wherein the IP update message contains an UPDATE identifier, a previous IP address of the first VoIP terminal, a changed IP address of the first VoIP terminal, and an IP address of the second VoIP terminal.
